(19) United States
(12) Patent Application Publication
(10) Pub. No.: US 2008/0000068 A1
(43) Pub. Date: Jan. 3, 2008

(54) Adjustment of work pallets for vehicle body assembly lines

(76) Inventors: Mark A. Savoy, Metamora, MI (US); Phillip J. I. Morgan, Commerce Township, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/477,106

(22) Filed: Jun. 28, 2006

(51) Int. Cl. B21D 39/03; B23P 11/00

(52) U.S. Cl. 29/429; 29/430; 29/822; 29/784

(57) ABSTRACT

Vehicle body assembly line apparatus includes a plurality of work pallets (14) having locators (18) with locator members (36) that are adjustable by a grab member (40) on each at a remote location below a vertical rest surface (37) mounted on each locator member. An adjusting station (16) provides either automatic adjustment of the adjustable locators (18) by one or more robots (52) or manual adjustment of the adjustable locators (18). A sensor (58) senses the location of a positioning target (56) on each locator member (36) at a known location from the vertical rest surface (37) and any locator pin (38) mounted thereon and generates a deviation signal when the positioning is not within a design tolerance. A control (60) readjusts the appropriate locator (18) as necessary to the design tolerance range.

### BACKGROUND OF THE INVENTION

1. Field of the Invention

This invention relates to: vehicle body assembly line apparatus having an adjusting station for adjusting work pallets on which vehicle body formed metal parts are assembled; the work pallets on which adjustable locators are supported for adjustment; and a method for assembling vehicle body formed metal parts by initially adjusting locators on work pallets.

2. Background Art

Vehicle bodies are conventionally manufactured on an assembly line wherein work pallets are moved in a recirculating manner during assembly of formed metal parts to each other. In one type of such assembly formed metal parts are assembled to each other while mounted on the work pallets as the pallets are moved along the assembly line. The assembly is conventionally performed in many different ways such as by the use of fasteners or welding which may either be electric resistance or laser welding, in addition to many other types of connection of the formed metal parts to each other. In one type of assembly, formed sheet metal parts are assembled to each other to provide a rigid vehicle body that also functions as the vehicle frame for mounting of wheel assemblies, the engine, the drivetrain and other vehicle components. In another type of vehicle body construction, longitudinal frame members are assembled to formed sheet metal members that are also secured to each other to provide the mounting of the vehicle body components.

Flexible manufacturing requires that vehicle body assembly lines be capable of manufacturing more than one vehicle model because some models cannot be produced and sold in a sufficient quantity to require a single devoted assembly line. Since high production vehicle body assembly lines normally have on the order of about 80 to 100 work pallets recirculated during the vehicle body assembly, there is considerable cost in providing the work pallets for any given vehicle model as well as requiring a large storage space for the work pallets when the assembly line is producing a different vehicle body model on another set of work pallets.

Vehicle body work pallets conventionally include a carriage on which locators are mounted. The locators conventionally include locator members having vertical rest surfaces some or all of which have upwardly projecting locator pins. Since different vehicle body models have many different shapes and sizes, the locator members must be mounted at different longitudinal (X), sideways (Y) and vertical (Z) positions, which necessitates the different work pallets for different vehicle body models and the resultant cost and storage space as discussed above. Certain of the locators have the locator pins that provide horizontal positioning in the longitudinal and sideways directions while the vertical rest surfaces provide vertical positioning of the parts being assembled. It is also conventional for the locator pins to have clamps which are selectively operable to provide clamping of the formed metal parts that are supported and positioned by the locator. The construction of such locator pin clamps involves an opening in the locator pin in which a clamp member is selectively movable from an unclamped position within the pin to a clamping position projecting outwardly from the pin and clamping the supported formed metal members. As such, the locator pins do not have a solid construction and can be deformed by forces applied to the locator pins.

In attempt to overcome the cost and storage problems involved with providing work pallets for different vehicle models, U.S. Pat. No. 6,687,971 Nakamura discloses transfer trucks on which adjustable locator jigs are mounted. Adjustment is provided by a jig change-over unit that includes a socket portion engagable with the corresponding locator pin of a locator jig to provide movement for the adjustment. However, the capability of providing such adjustment is limited by the engagement with the locator pin because the locator pin is normally remote from slides along which the adjustment takes place. As such, this adjustment cannot be provided in all three axes of adjustment at the same time.

Other references noted during investigation conducted in connection with the present application is disclosed by U.S. Pat. Nos. 4,594,764 Yamamoto; 4,667,866 Tobita et al.; 4,751,995 Naruse et al.; 4,776,085 Shiiba; 4,939,838 Gatta; 4,951,931 Rossi; 5,203,814 Kushizaki et al.; 5,313,695 Negre et al.; 5,347,700 Tominaga et al.; 5,518,166 Numata et al.; 5,836,068 Bullen et al.; 5,920,974 Bullen; 5,943,768 Ray; 6,065,200 Negre; 6,089,440 Brusha; 6,115,907 Beyer; 6,164,634 Farlow; 6,202,275 Cioletti et al.; 6,378,186 Angel; 6,389,698 Malatier; 6,427,321 Fedato et al.; 6,467,675 Ozaku et al.; 6,546,616 Radowick; and United States Patent Publications: 2001/0013164 Morel et al.; 2002/0023334 Rhoads et al.; 2002/0038855 Hwang; and 2002/0170160 Savoy et al.

### SUMMARY OF THE INVENTION

An object of the present invention is to provide an improved vehicle body assembly line apparatus including work pallets that can be adjusted for use with different model vehicle bodies for assembling formed metal parts to each other during successive cycies.

In carrying out the above object, the vehicle body assembly line apparatus of the invention for use in cyclically assembling formed metal parts for vehicle bodies of different models during successive cycles includes a plurality of work pallets that are sequentially movable along an assembly line to support formed metal parts being assembled to each other. Each work pallet includes a carriage supporting a plurality of adjustable locators each of which includes a locator member for mounting a vertical rest surface with a plurality of the rest surfaces including a locator pin extending upwardly therefrom for providing part positioning during the assembly. Each locator member has a grab member located at a remote location below the mounting location of its vertical rest surface. A linear bearing supports each locator member on the carriage for adjusting movement along a linear axis. Each locator includes a brake having a locked condition for holding its locator member in an adjusted position and having an unlocked condition where the locator member thereof is freely movable for adjustment along the axis of its linear bearing.

An adjusting station of the apparatus is located at an upstream end of the assembly line to which the work pallets are successively moved to begin the assembly of formed metal parts for each cycle. At the adjusting station, the grab members of the locator members of the locators on the work pallets are grasped and with the brakes thereof in their unlocked condition moved as necessary to provide adjustment of the locator pins along their linear bearings to the proper positions for the particular vehicle body model to be assembled on each work pallet during the next cycle.

The vehicle body assembly line apparatus as disclosed has the adjusting station including an adjuster for adjusting the locators. The adjuster station includes at least one programmable robot for providing the locator adjustment, and for greater production levels the adjuster station includes a plurality of programmable robots for providing the locator adjustment.

Each locator member as disclosed has a positioning target at a known location with respect to where its vertical rest surface is mounted. The adjusting station includes a sensor for sensing the adjusted position of the positioning target on the locator member to determine whether the positioning target thereof is positioned within a design tolerance range and for generating a deviation signal when the positioning target is not located within the design tolerance range. The adjusting station includes a control for operating the adjuster to readjust the appropriate locator in response to the deviation signal to provide positioning of the associated locator positioning target within the design tolerance range.

A plurality of the locators on each work pallet have linear bearings that provide at least vertical locator adjustment on the carriage, and for all position of required adjustment a plurality of the locators on each work pallet have linear bearings that provide vertical, longitudinal and sideways locator adjustment on the carriage.

The vehicle body assembly line disclosed is specifically designed to assembly formed sheet member parts to each other.

Another object of the present invention is to provide an improved work pallet for use in a vehicle body assembly line to cyclically assemble formed metal for vehicle bodies of different models during movement through the assembly line.

In carrying out the immediately preceding object, the vehicle body work pallet of the invention includes a carriage and a plurality of adjustable locators each of which includes a locator member for mounting a vertical rest surface with a plurality of the rest surfaces having a locator pin extending upwardly therefrom to provide part positioning during assembly on the pallet. Each locator member has a grab member located at a remote location below the mounting location of its vertical rest surface. Each locator includes a linear bearing for supporting its locator member on the carriage for adjusting movement along a linear axis. A brake of each locator has a locked condition for holding its locator member in an adjusted position and has an unlocked condition where the locator member thereof is freely movable by grasping of its grab member at its remote location below its vertical rest surface.

Each locator of the work pallet includes a positioning target at a known location with respect to where its vertical rest surface is mounted to permit sensing of the locator member positioning and any necessary readjustment upon sensing an out of tolerance position after the initial adjustment. A plurality of the locators on the work pallet each includes a linear bearing that supports the locator member thereof on the carriage for vertical adjustment, and for all positions of required adjustment a plurality of the locators on the work pallet each includes linear bearings that support the locator member thereof on the carriage for vertical, longitudinal and sideways adjustment.

Another object of the present invention is to provide an improved method for cyclically assembling formed metal parts for different model vehicle bodies.

In carrying out the immediately preceding object, the method for cyclically assembling formed metal parts of different model vehicle bodies is performed by cyclically moving work pallets to an upstream adjusting station of an assembly line, and adjustable locators are unlocked on each work pallet to permit adjustment of locator members thereof for freely movable adjustment of the locator members and vertical rest surfaces thereof as well as locator pins on a plurality of the locator members along at least one linear axis on a carriage of the work pallet. A grab member on each locator member at a remote location below its vertical rest surface is grasped to adjust the position of the locator member and its vertical rest surface as necessary for the vehicle body model formed metal parts to be assembled during the next cycle.

As disclosed, the location of a positioning target on each locator member is sensed after the adjustment to determine whether the positioning target, which is at a known position with respect to the vertical rest surface is within a design tolerance range to thereby determine whether the locator member is properly located. Thereafter readjusting and sensing of the location of the positioning targets is performed as necessary until the locator members and are all properly positioned.

At least one programmable robot is operated to provide the adjustment of the locator members on the carriage, and as disclosed a plurality of programmable robots are operated to provide the adjustment of the locator members on the carriage.

The locator members are adjusted along a vertical axis and for all required positioning are adjusted along vertical, longitudinal and sideways axes.

### BRIEF DESCRIPTION OF THE DRAWINGS

FIG. 1 is a schematic top plan view of a vehicle body assembly line that embodies the present invention and performs a method of vehicle body assembly in accordance with the invention.

FIG. 2 is a perspective view of a work pallet for use in assembling vehicle body formed metal parts in accordance with the invention.

FIG. 3 is a top plan schematic view for illustrating the operation of adjustable locators on the work pallets of the assembly line.

FIG. 4 is a perspective view taken from an outboard direction of one of the adjustable locators of the work pallets.

FIG. 5 is a perspective view of the adjustable locator taken from an inboard direction.

FIG. 6 is a schematic view that illustrates a control brake utilized with linear bearings of the adjustable locators.

FIG. 7 is a schematic view illustrating a sensor used to provide any required locator positioning adjustment.

### DETAILED DESCRIPTION OF THE PREFERRED EMBODIMENTS

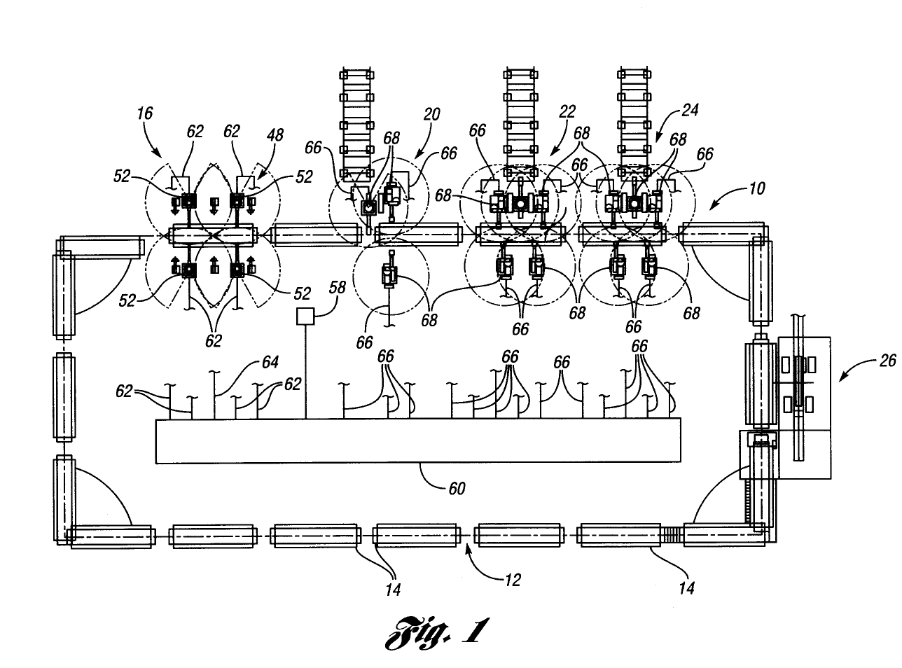

With reference to FIG. 1 of the drawings, a vehicle body assembly line generally indicated by 10 includes a schematically indicated conveyor 12 for conveying work pallets 14 during assembly of formed metal parts to each other to provide vehicle bodies. During such assembly, the work pallets 14 are conveyed by the conveyor 12 in a clockwise direction starting at an initial adjusting station 16 where adjustable locators 18 (FIG. 2) are adjusted as is hereinafter more fully described. From the adjusting station 16 shown in FIG. 1, the work pallets 14 are conveyed toward the right to a front floor panel supply station 20, then to a center floor panel supply and assembly station 22, then to a rear floor panel supply and assembly station 24 where the assembly is completed, and finally to an unload station 26 prior to continued clockwise movement to the left along a return run back to the adjusting station 16. The adjustment of the locators 18 of work pallets 14 at the adjusting station 16 permits the assembly line to accommodate vehicle body assembling of different models and can also provide adjustment of each work pallet after each assembly cycle so as to ensure that the locators are properly located in preparation for the next cycle.

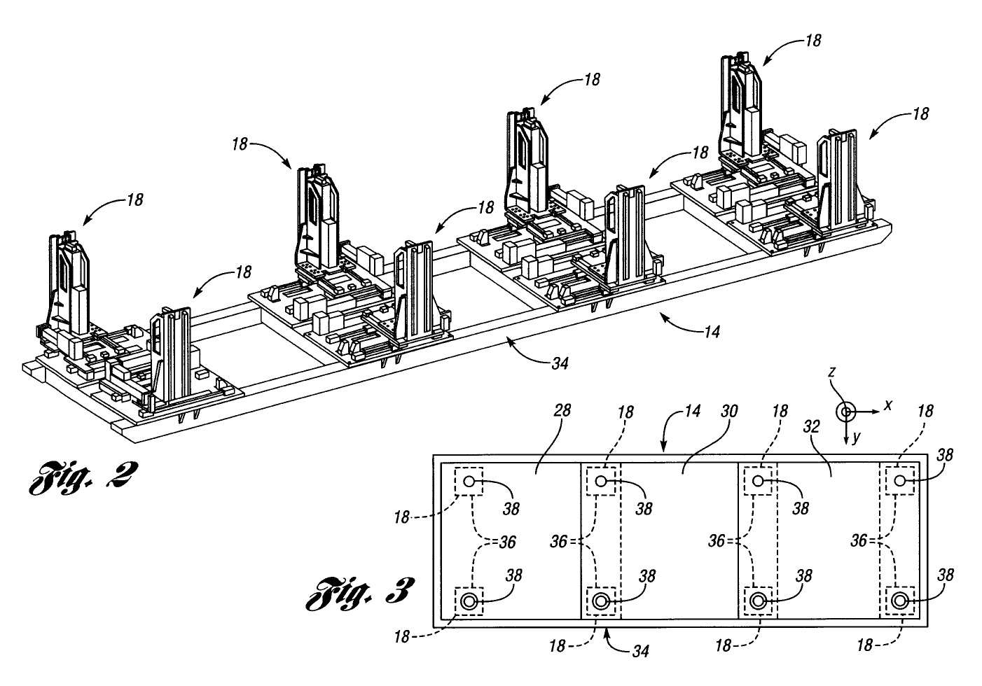

The vehicle body assembly line construction, the work pallet construction and the vehicle body assembling method of the invention will be described in an integrated manner to facilitate an understanding of all aspects of the invention. Also, it is should be appreciated that while the assembly line is disclosed as assembling front, center and rear formed sheet metal floor parts 28, 30 and 32 as shown in FIG. 3, the assembly can also be performed with other formed metal parts, such as, for example, assembly of longitudinal frame members to formed sheet metal body panels.

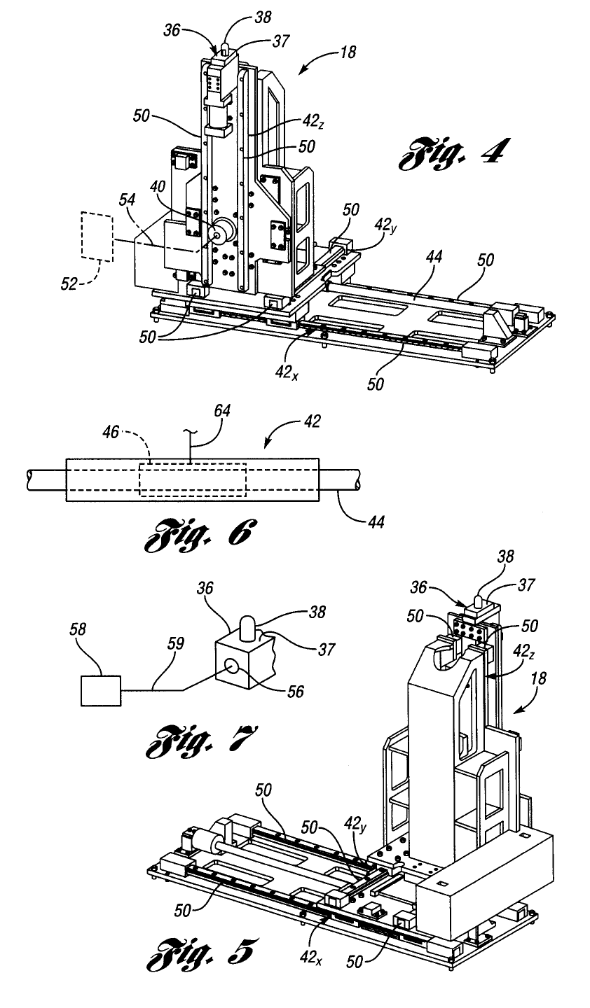

As shown in FIG. 3, each work pallet 14 includes a carriage 34 on which the adjustable locators 18 are mounted. Each locator as shown in FIGS. 4 and 5 and schematically in FIG. 7 includes a locator member 36 having a vertical rest surface 37 mounted thereon and a locator pin 38 also mounted thereon and extending upwardly from vertical rest surface 37 mounted on the locator member to be capable of providing part positioning of the assembly. More specifically, the vertical rest surface 37 of each locator member 36 is adjustable vertically and supports the parts being assembled to provide positioning in a vertical direction, i.e. the Z direction shown in FIG. 3. Furthermore, the locator member 36 is horizontally adjustable so its locator pin 38 is capable of providing positioning of the parts in longitudinal and sideways directions as respectively illustrated by X and Y in FIG. 3. Each locator member 36 as shown in FIG. 4 has a grab member 40 that is located at a remote position below the mounting location of its vertical rest surface 37 to provide the adjustment as is hereinafter more fully described. A linear support bearing 42 shown in FIGS. 4 and 5 supports the locator member 36 for adjusting movement of its vertical rest surface and associated locator pin 38. As specifically shown in FIG. 5, the locator member 36 is directly supported by a vertical linear bearing 42z which is in turn supported by a sideways linear support bearing 42y that is supported by a longitudinal support bearing 42x. Each of these linear support bearings as shown in FIG. 6 includes a bearing rod 44 and a brake 46 that has a locked condition for holding its locator member in an adjusted position along its associated direction and also has an unlocked condition where the locator member thereof is freely movable for adjustment along the axis of its linear bearing.

For some low production vehicle body assembly lines, it is possible to utilize manual grasping of the grab member 40 of each locator member 36 as shown in FIG. 4 to permit adjustment to the required position along the vertical Z axis and, as shown, likewise along the sideways Y axis and the longitudinal X axis. For higher production assembly lines, it is preferable to utilize an adjuster 48 as shown in FIG. 1 at the adjusting station. Regardless of whether a manual or automatic adjuster is utilized, the remote location of the grab member 40 from the vertical rest surface 37 and locator pin 38 of the locator member 36 facilitates the adjustment. As specifically shown in FIG. 4, the grab member 40 is located vertically below the locator pin 38 relatively close to the sideways linear bearing 42y and longitudinal linear bearing 42x. Each linear bearing includes a pair of linear bearing slides 50 extending parallel to its bearing rod. The remote location of the grab member 40 from the vertical rest surface 37 and locator pin 38 of the locator member 36 facilitates the adjustment without binding of these bearing slides 50 and permits adjustment in all three directions by a single movement without the requirement of initial adjusting in one direction and then subsequent adjustment in two other directions as has been required in the prior art.

The adjuster 48 of adjusting station 16 shown in FIG. 1 includes at least one robot 52 whose arm 54 as schematically identified in 54 has an end effector for grabbing the grab member 40 and providing the locator member adjustment as described above. Preferably there are a plurality of the adjusting robots 52 with one robot dedicated to each of two of the adjustable locators 18 shown in FIG. 2 so as to provide a more rapid adjusting cycle.

As illustrated in FIG. 7, each of the locator members 36 on which the locator pins 38 are mounted has a positioning target 56 at a known location with respect to the vertical rest surface and hence also with respect to the locator pin. The positioning target 56 is most preferably constructed with a sharp edge such as provided by a hole to facilitate sensing of its position by a sensor 58 that projects a sensing signal 59. Since the locator pins often have hollow interiors to receive clamp members used for providing part clamping, it is preferably for the positioning target to be remote from the locator pin although in some constructions the positioning target can be on the locator pin. The sensing signal 59 from the sensor 58 senses the location of the positioning target 56 to determine whether the positioning target is positioned within a design tolerance range. A deviation signal is generated by the sensor 58 when the positioning target 56 and thus the vertical rest surface 37 and the locator pin 38 are not located within the design tolerance range. It should be noted that the sensing of the location of the positioning target 56 senses its position in the longitudinal X, sideway Y and vertical Z directions regardless of whether the locator member 36 also has a positioning pin 38 or not.

Adjusting station 16 shown in FIG. 1 includes a control 60 that senses the deviation signal from the sensor 58 and through connections 62 to the adjusting robots 52 provides readjusting of the appropriate locator in response to the deviation signal to provide positioning of the associated locator positioning target within the design tolerance range. The sensing and readjustment can be performed as many times as necessary until the positioning is within the design tolerance range. Control 60 also has a connection 64 as shown in FIGS. 1 and 6 to the linear bearing brakes 46 so as to provide their locked and unlocked conditions as previously described. Furthermore, control 60 has connections 66 to supply and assembly robots 68 of the front, center and rear part stations 20, 22 and 24 previously described.

With reference to FIG. 3, the assembly line has the adjustable locators positioned on the work pallet carriages 34 along their lengths at each lateral side along the longitudinal X direction. On the upper side as illustrated, the adjustable locator 18 farthest to the left and the second from the right have close tolerance spacing of the locator pins 38 and positioning holes in the floor parts 28, 30 and 32 being assembled. Furthermore, the locator 18 farthest to the right and the second locator from the left have close tolerance locator pin and part hole positioning in the sideways Y direction so as prevent rotation of the parts 28, 30 and 32. On the other lateral side of the work pallet carriage 34, the locators 18 only provide vertical part positioning on their vertical rest surfaces since the locator pins 38 of the locators have a greater tolerance spacing with the associated positioning holes in the parts 28, 30 and 32 and thus provide only an initial rough horizontal part positioning without any binding with the positioning provided by the locator pins and part holes on the other lateral side of the work pallet as described above. In fact, these locators 18 that provide only vertical part positioning and do not provide horizontal part positioning do not necessarily have to have positioning pins mounted thereon projecting upwardly from their vertical rest surfaces.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. Vehicle body assembly line apparatus for use in cyclically assembling formed metal parts for vehicle bodies of different models during successive cycles, comprising:
a plurality of work pallets that are sequentially movable along an assembly line to support formed metal parts being assembled to each other;
each work pallet including a carriage and a plurality of adjustable locators each of which includes a locator member for mounting a vertical rest surface with or without a locator pin extending upwardly from its vertical rest surface for providing part positioning during the assembly, each locator member having a grab member located at a remote location below the mounting location of its vertical rest surface, a linear bearing for supporting each locator member on the carriage for adjusting movement along a linear axis, and each locator including a brake having a locked condition for holding its locator member in an adjusted position and having an unlocked condition where the locator member thereof is freely movable for adjustment along the axis of its linear bearing; and
an adjusting station, at an upstream end of the assemble line to which the work pallets are successively moved to begin the assembly of formed metal parts for each cycle, where the grab members of the locator members of the locators on the work pallets are grasped and with the brakes thereof in their unlocked condition moved as necessary to provide adjustment along their linear bearings to the proper positions for the particular vehicle body model to be assembled on each work pallet during the next cycle.

2. Vehicle body assembly line apparatus as in claim 1 wherein the adjusting station includes an adjuster for adjusting the locators.

3. Vehicle body assembly line apparatus as in claim 2 wherein the adjuster of the adjuster station includes at least one programmable robot for providing the locator adjustment.

4. Vehicle body assembly line apparatus as in claim 2 wherein the adjuster of the adjuster station includes a plurality of programmable robots for providing the locator adjustment.

5. Vehicle body assembly line apparatus as in claim 1 wherein each locator member has a positioning target at a known location with respect to where its vertical rest surface is mounted, the adjusting station including a sensor for sensing the adjusted position of the positioning target on the locator member to determine whether the positioning target thereof is positioned within a design tolerance range and for generating a deviation signal when the positioning target is not located within the design tolerance range.

6. Vehicle body assembly line apparatus as in claim 5 wherein the adjusting station includes an adjuster for adjusting the locators and also includes a control for readjusting the appropriate locator in response to the deviation signal to provide positioning of the associated locator positioning target within the design tolerance range.

7. Vehicle body assembly line apparatus as in claim 1 wherein a plurality of the locators on each work pallet have linear bearings that provide at least vertical locator adjustment on the carriage.

8. Vehicle body assembly line apparatus as in claim 1 wherein a plurality of the locators on each work pallet have.linear bearings that provide vertical, longitudinal and sideways locator adjustment on the carriage.

9. Vehicle body assembly line apparatus for use in cyclically assembling formed metal parts for vehicle bodies of different models during successive cycles, comprising:
a plurality of work pallets that are sequentially movable along an assembly line to support formed metal parts being assembled to each other;
each work pallet including a carriage and a plurality of adjustable locators each of which includes a locator member for mounting a vertical rest surface with or without a locator pin extending upwardly from its vertical rest surface for providing part positioning during the assembly, each locator member having a positioning target at a known location with respect to its vertical rest surface and also having a grab member located at a remote location below the mounting location its vertical rest surface, linear bearings for supporting each locator member on the carriage for adjusting movement along vertical, longitudinal and sideways axes, and brakes having a locked condition for holding each locator member in an adjusted position and having an unlocked condition where the locator member is freely movable for adjustment along the axes of its linear bearings;
an adjusting station at an upstream end of the assemble line to which the work pallets are successively moved to begin the assembly of formed metal parts for each cycle, the adjusting station including at least one programmable robot for adjusting the locators on the work pallets with the brakes thereof in their unlocked condition, and the robot adjustment of the locators being provided by robot grasping of the grab member of the locator members of each locator to provided positioning of the locator members as necessary on their linear bearings for the particular vehicle body model to be assembled on each work pallet during the next cycle;
a sensor for sensing the adjusted position of the positioning target on each locator member to determine whether the positioning target is adjusted to within a design tolerance range and for generating a deviation signal when the positioning target is not located within the design tolerance range; and
a control for readjusting the associated locator member positioning in response to the deviation signal to provide positioning of the associated positioning target within the design tolerance range.

10. Vehicle body assembly line apparatus for use in cyclically assembling formed sheet metal parts for vehicle bodies of different models during successive cycles, comprising:
a plurality of work pallets that are sequentially movable along an assembly line to support formed sheet metal parts being assembled to each other;
each work pallet including a carriage and a plurality of adjustable locators each of which includes a locator member for mounting a vertical rest surface with or without a locator pin mounted on its locator member extending upwardly from its vertical rest surface for providing part positioning during the assembly, each locator member having a positioning target at a known location with respect to its vertical rest surface and also having a grab member at a remote location below the mounting location of the vertical rest surface, linear bearings for supporting each locator member on the carriage for adjusting movement along vertical, longitudinal and sideways axes, and brakes having a locked condition for holding each locator member in an adjusted position and having an unlocked condition where the locator member is freely movable for adjustment along the axes of its linear bearings;
an adjusting station at an upstream end of the assemble line to which the work pallets are successively moved to begin the assembly of formed metal parts for each cycle, the adjusting station including a plurality of programmable robots for adjusting the locators on the work pallets with the brakes thereof in their unlocked condition, and the robot adjustment of the locators being provided by robot grasping of the grab member of the locator member of each locator to provided positioning of the locator members as necessary on their linear bearings for the particular vehicle body model to be assembled on each work pallet during the next cycle;
a sensor for sensing the adjusted position of the positioning target on each locator member to determine whether the positioning target is adjusted to within a design tolerance range and for generating a deviation signal when the positioning target is not located within the design tolerance range; and
a control for readjusting the associated locator member positioning in response to the deviation signal to provide positioning of the associated positioning target within the design tolerance range.

11. A work pallet for use in a vehicle body assembly line to cyclically assemble formed metal parts for vehicle bodies of different models during successive cycles of movement through the assembly line, the work pallet comprising:
a carriage;
a plurality of adjustable locators each of which includes a locator member for mounting a vertical rest surface with a plurality of the rest surface having a locator pin extending upwardly therefrom to provide port positioning during assembly on the pallet, each locator member having a grab member located at a remote location below the mounting location of its vertical rest surface;
each locator including a linear bearing for supporting each locator member on the carriage for adjusting movement along a linear axis; and
each locator including a brake having a locked condition for holding its locator member in an adjusted position and having an unlocked condition where the locator member thereof is freely movable by grasping of its grab member at its remote location below its vertical rest surface for adjustment along the axis of its linear bearing.

12. A vehicle body assembly line work pallet as in claim 11 wherein each locator member includes a positioning target at a known location with respect to where its vertical rest surface is mounted to permit sensing of the locator member positioning and any necessary readjustment upon sensing an out of tolerance position after the initial adjustment.

13. A vehicle body assembly line work pallet as in claim 11 wherein a plurality of the locators each includes a linear bearing that supports the locator member thereof on the carriage for vertical adjustment.

14. A vehicle body assembly line work pallet as in claim 11 wherein a plurality of the locators each includes linear bearings that support the locator member thereof on the carriage for vertical, longitudinal and sideways adjustment.

15. A method for cyclically assembling formed metal parts for different model vehicle bodies, comprising:
cyclically moving work pallets to an upstream adjusting station of an assembly line;
unlocking locators on each work pallet to permit adjustment of locator support thereof for freely movable adjustment of the locator members and vertical rest surfaces thereof as well as locator pins on a plurality of the locator members along at least one linear axis on a carriage of the work pallet; and
grasping a grab member located on each locator member at a remote location below its vertical rest surface to adjust the position of each locator member and its vertical rest surface as necessary for the vehicle body model formed metal parts to be assembled during the next cycle.

16. A method for cyclically assembling formed metal vehicle body parts as in claim 15 wherein the location of a positioning target on each locator member is sensed after the adjustment to determine whether the positioning target, which is at a known position with respect to the vertical rest surface, is within a design tolerance range to thereby determine whether the locator member is properly located, and thereafter readjusting and sensing the location of the positioning targets as necessary until the locator members are all properly positioned.

17. A method for cyclically assembling formed metal vehicle body parts as in claim 15 wherein at least one programmable robot is operated to provide the adjustment of the locator members on the carriage.

18. A method for cyclically assembling formed metal vehicle body parts as in claim 15 wherein a plurality of programmable robots are operated to provide the adjustment of the locator members on the carriage.

19. A method for cyclically assembling formed metal vehicle body parts as in claim 15 wherein the locator members are adjusted along a vertical axis.

20. A method for cyclically assembling formed metal vehicle body parts as in claim 15 wherein the locator members are adjusted along vertical, longitudinal and sideways axes.

21. A method for cyclically assembling formed metal parts for different model vehicle bodies, comprising:
cyclically moving work pallets to an upstream adjusting station of an assembly line;
unlocking locators on each work pallet at the adjustment station to permit adjustment of locator members thereof having vertical rest surfaces for freely movable adjustment along vertical, longitudinal and sideways axes on a carriage of the work pallet;
operating at least one programmable robot at the adjusting station to grasp grab members of the locator members at remote locations below their vertical rest surfaces to adjust the vertical rest surfaces of the locator members and locator pins on a plurality of the locator members along the vertical, longitudinal and sideways axes on each work pallet as necessary for the vehicle formed metal vehicle body parts to be assembled on the work pallet during the next cycle;
sensing the location of a positioning target on each locator member to determine whether the positioning target, which is at a known position with respect to its vertical rest surface, is within a design tolerance range to thereby determine whether the locator member is properly located; and
readjusting and sensing the location of the positioning target of each locator as necessary until the locator member is properly positioned.

22. A method for cyclically assembling formed sheet metal parts for different model vehicle bodies from formed metal parts, comprising:
cyclically moving work pallets to an upstream adjusting station of an assembly line;
unlocking locators on each work pallet at the adjustment station to permit adjustment of locator members thereof having vertical rest surfaces for freely movable adjustment along vertical, longitudinal and sideways axes on a carriage of the pallet;
operating a plurality of programmable robots at the adjusting station to grasp grab members of the locator members at remote locations below their vertical rest surfaces to adjust the vertical rest surfaces of the locator members and locator pins on a plurality of the locator members along the vertical, longitudinal and sideways axes on each work pallet as necessary for the vehicle formed sheet metal vehicle body parts to be assembled on the work pallet during the next cycle;
sensing the location of a positioning target on each locator member to determine whether the positioning target, which is at a known position with respect to its vertical rest surface member, is within a design tolerance range to thereby determine whether the locator pin is properly located; and
readjusting and sensing the location of the positioning target of each locator as necessary until the locator member is properly positioned.
